(19) United States
(12) Patent Application Publication
(10) Pub. No.: US 2010/0033009 A1
(43) Pub. Date: Feb. 11, 2010

(54) Method and Device for Tightening a Hydraulic Parking Brake

(75) Inventor: Josef Knechtges, Mayen (DE)

Correspondence Address: MACMILLAN, SOBANSKI & TODD, LLC, ONE MARITIME PLAZA - FIFTH FLOOR, 720 WATER STREET, TOLEDO, OH, 43604, US

(73) Assignee: LUCAS AUTOMOTIVE GMBH, Koblenz (DE)

(21) Appl. No.: 11/992,881

(22) PCT Filed: Sep. 27, 2006
(86) PCT No.: PCT/EP2006/009409

§ 371 Date: Apr. 6, 2009

(30) Foreign Application Priority Data
Sep. 30, 2005 (DE) 10 2005 046 991.4

(51) Int. Cl. B60T 8/32; B60T 7/10

(52) U.S. Cl. 303/191; 477/197

(57) ABSTRACT

A method and a device for tightening a hydraulic parking brake are disclosed. In the method, a tightening force is generated in a first step by creating a hydraulic pressure in a parking brake circuit. To this end, a pressure generating unit driven by an electric motor is used. In a subsequent step, at least one motor-related parameter which permits a conclusion about the hydraulic pressure prevailing in the parking brake circuit is detected. Subsequently, an activation of a tightening force assistance device takes place depending on the detected motor-related parameter and without the necessity of providing a pressure sensor.

### CROSS-REFERENCE TO RELATED APPLICATIONS

This application is a National Stage of International Application No. PCT/EP2006/009409 filed Sep. 27, 2006, the disclosures of which are incorporated herein by reference in their entirety, and which claimed priority to German Patent Application No. 10 2005 046 991.4 filed Sep. 30, 2005, the disclosures of which are incorporated herein by reference in their entirety.

### BACKGROUND OF THE INVENTION

The invention generally relates to the field of hydraulic parking brakes. In particular, the invention relates to such parking brakes in which an electromotively-operated pressure generating unit is provided for creating a hydraulic pressure.

A hydraulic vehicle brake is known from EP 0 996 560 A1, and corresponding U.S. Pat. No. 6,394,235, both of which are incorporated by reference herein, which may be used both as a service brake and also as a parking brake (also known as holding brake). In a service brake system, pressurised hydraulic fluid is generally introduced into a hydraulic chamber defined by a movable brake piston. The pressure created in the hydraulic chamber leads to the displacement of the brake piston and a friction lining cooperating with the brake piston in the direction of a brake disc which is braked by the friction lining which is pressed thereagainst.

So that the vehicle brake is not only able to be used as a service brake but also as a parking brake, it comprises an electromotively-operated nut/spindle arrangement. The nut/spindle arrangement permits a mechanical actuation of the brake piston as well as a securing of the brake piston in a state in which the friction lining is pressed against the brake disc.

So that a vehicle may be securely parked on an inclined road by the assistance of the parking brake, high tightening forces are required. In order to be able to generate high tightening forces by means of the nut/spindle arrangement, the electromotive operation for the nut/spindle arrangement accordingly has to be designed to be powerful.

In order to be able to provide a saving in weight and constructional space, less powerful drives for the nut/spindle arrangement have been proposed to tighten the brake piston in parking brake mode by means of a hydraulically produced tightening force. The production of the hydraulic tightening force in parking brake mode generally takes place irrespective of the actuation of the brake pedal on the part of the driver. For this reason, electromotively-operated pumps are used for creating the hydraulic pressure in a parking brake circuit. The hydraulic (pre)tightened parking brake is further tightened and/or secured by means of the nut/spindle arrangement or another tightening force assistance device.

In conventional hydraulic parking brakes, an actuation of the nut/spindle arrangement is carried out according to the hydraulic pressure prevailing in the parking brake circuit. Hitherto, pressure sensors have been provided for detecting the hydraulic pressure in parking brake mode.

### BRIEF SUMMARY OF THE INVENTION

The object of the invention is to provide a technique for detecting, without pressure sensors, the hydraulic pressure prevailing in the parking brake circuit.

According to a first aspect of the invention, a method for tightening a hydraulic parking brake is proposed which comprises the steps of generating a tightening force by creating a hydraulic pressure in a parking brake circuit using a pressure generating unit driven by an electric motor, detecting at least one motor-related parameter which permits a conclusion about the hydraulic pressure prevailing in the parking brake circuit, and activating a tightening force assistance device depending on the detected motor-related parameter.

The activation of the tightening force assistance device is, therefore, not carried out according to a signal from a pressure sensor, at least not exclusively. Instead, a motor-related parameter is taken into consideration during the activation which permits a conclusion about the hydraulic pressure prevailing in the parking brake circuit. Thus the tightening force assistance device may, for example, be actuated when the detected motor-related parameter indicates a sufficiently high hydraulic pressure in the parking brake circuit. In this case, the value of the detected parameter may be compared with a predefined value (for example a threshold value).

A plurality of motor-related parameters exist which permit a return to the hydraulic pressure prevailing in a brake circuit and, in particular, in the parking brake circuit. The motor drive torque, for example, is included in these parameters. The higher the drive torque of the electric motor, generally the higher the hydraulic pressure prevailing in the braking circuit. The power consumption (for example the current requirement) of the electric motor is also included in the pressure-dependent parameters, which also allows a return to the motor drive torque. If the electric motor is activated by means of pulse width modulation, an average power consumption is detected from the pulse widths. The average power consumption may be determined by temporal integration or extrapolation of the pulse.

The speed of the electric motor (or the speed of the pressure generating unit coupled to the electric motor) may be cited as a further motor-related parameter, which permits a conclusion about the hydraulic pressure prevailing in the parking brake circuit. Thus, for example, a fall in speed without loss of activation indicates a pressure rise (and vice-versa). The speed detection is preferably based on a measurement of the generator voltage produced by the electric motor. The generator voltage produced is in a fixed ratio with the motor speed. If the electric motor is activated by means of pulse width modulation, the generator voltage may be measured in the pulse intervals.

In order to ensure accurate activation of the tightening force assistance device, the activation may take place according to two or more detected motor-related parameters. For example, the tightening force assistance device may be actuated when, with reducing speed, the power consumption rises. Both rising power consumption and reducing speed imply, namely, a rise in pressure in the parking brake circuit.

The tightening force assistance device is preferably configured to generate a tightening force (additionally to the hydraulically applied pressure) and/or to maintain a generated tightening force. In this case it may be a mechanical device (for example, motor-driven), for example in the manner of a nut/spindle arrangement.

According to a further aspect of the invention, a method for detecting the hydraulic pressure in a braking circuit without sensors, in particular a parking brake circuit, is provided with an electromotively-operated pressure generating unit, activated by means of pulse width modulation. The method comprises the steps of temporal integration or extrapolation of the pulses to detect a motor-related parameter in the form of an average power consumption and determining the hydraulic pressure on the basis of the detected power consumption.

The invention further provides a device for tightening a hydraulic parking brake. The device comprises an electric motor, a pressure generating unit driven by the electric motor, which creates a hydraulic pressure for generating a tightening force in a parking brake circuit, a tightening force assistance device for the parking brake as well as a control device for detecting at least one motor-related parameter which permits a conclusion about the hydraulic pressure prevailing in the parking brake circuit, and for activating the tightening force assistance device depending on the detected motor-related parameter.

The pressure generating unit is either specifically and exclusively provided for the inventive purpose or is a component already present in the braking system. Thus the pressure generating unit may be a component of a system for improving the driving stability, for example an ABS pump or ESP pump.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a hydraulic parking brake system with a tightening device according to the invention;

FIG. 2 shows a flow chart of a first embodiment of a method for tightening a parking brake; and

FIG. 3 shows a flow chart of a second embodiment of a method for tightening a parking brake.

### DETAILED DESCRIPTION OF THE INVENTION

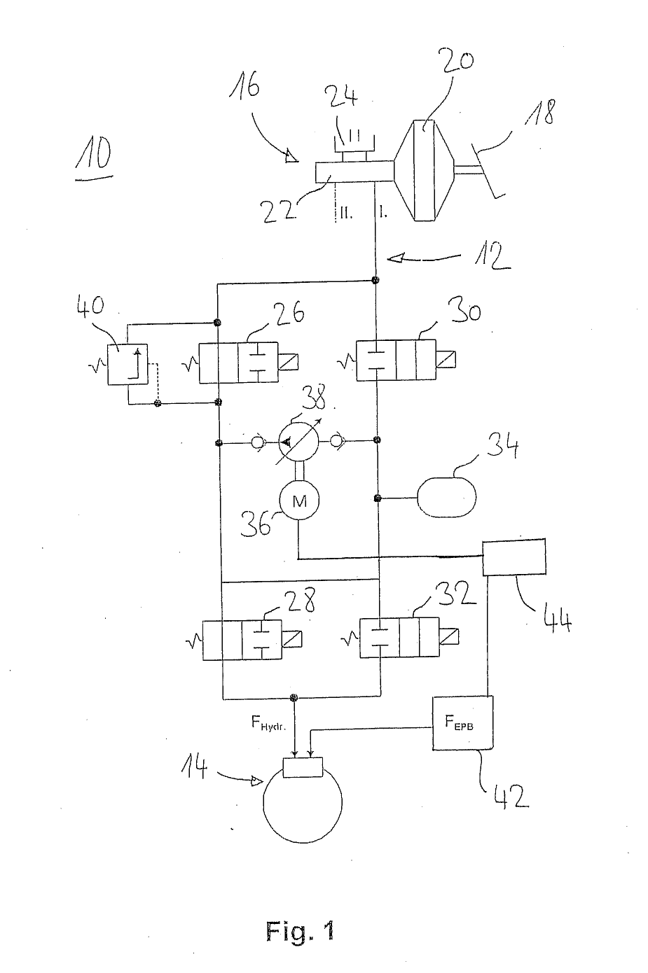

FIG. 1 shows an embodiment of a braking system 10 with a hydraulic parking brake function. The braking system 10 comprises two separate hydraulic circuits with a split brake circuit, for example of the x-split type. For the sake of simplicity, in FIG. 1 only one hydraulic circuit 12 is shown in more detail, together with only one wheel brake 14.

For service braking operations, a conventionally designed brake pressure generating unit 16 is provided. The brake pressure generating unit 16 comprises a brake pedal 18, a brake booster 20, a master cylinder 22 coupled to both brake circuits as well as a unpressurised reservoir 24 for hydraulic fluid. Departing from the embodiment shown in FIG. 1, in which the wheel brake pressure for service braking operations is generated by foot force, the invention could, however, also be implemented in brake-by-wire systems.

In the only brake circuit 12 shown in FIG. 1, four valve arrangements 26, 28, 30, 32 are provided, a pressure accumulator 34 for hydraulic fluid as well as an ESP hydraulic unit with an electric motor 36 and a pressure generating unit 38 in the form of a pump driven by the electric motor 36 as generally known. An overpressure component 40 is associated with the valve 26. Within the scope of parking brake mode, a tightening force assistance device 42 as well as an electrical control device 44 coupled to the tightening force assistance device 42 and the electric motor 36 are used in addition to these components. In the embodiment, the tightening force assistance device 42 contains a mechanical locking component, for example in the form of a nut/spindle arrangement, as well as a motor drive provided therefore (neither are shown in FIG. 1).

For tightening the wheel brake 14 in the parking brake mode, initially a hydraulic pressure is created by the pressure generating unit 38 driven by the electric motor 36, in the resulting parking brake circuit when the valves 26 and 32 are closed and the valves 28 and 30 are open. The hydraulic pressure being created generates a brake application force in the wheel brake 14. During the operation of the motor, accompanied by the pressure generation, the control unit 44 coupled to the electric motor 46 detects the motor drive torque. The motor drive torque generated by the electric motor 36 is then evaluated as a measure or indication of the hydraulic pressure prevailing in the parking brake circuit. As soon as the motor drive torque reaches or exceeds a predetermined value, the control device 44 activates the tightening force assistance device 42 in order to increase or to maintain the hydraulically generated brake application force mechanically. The motor drive torque may, for example, be detected from the measured power consumption of the electric motor 36.

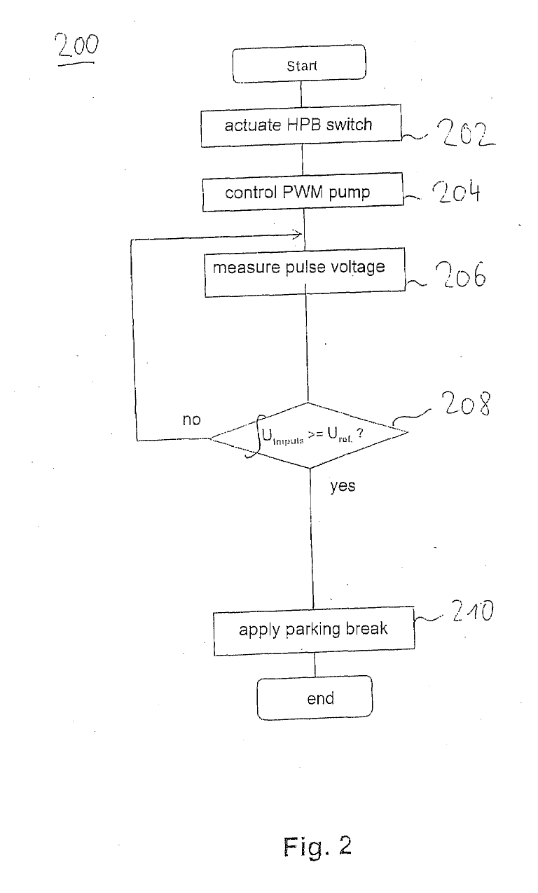

A first embodiment of a method for tightening a hydraulic parking brake (HPB) is described hereinafter by referring to the flow chart 200 of FIG. 2. In a first step 202 of the method, the driver activates the parking brake in which he or she actuates an HPB switch. The hydraulic parking brake could, however, also be activated irrespective of a specific driver demand and automatically by a control device (for example when stopping and driving in hilly terrain).

Subsequently to the activation of the hydraulic parking brake, the electric motor of an ESP or ABS supply pump is activated by a control unit by means of pulse width modulation (PWM) according to a predetermined control program. During pulse width modulation, the electric motor during the (variable) pulse duration is supplied with a predetermined pulse voltage U_{Impuls}. The electric motor is thus supplied with current during the pulse duration, and not supplied with current during the interim time. The ratio of the pulse duration (switched-on time) to the interval time (switched-off time) determines the speed of the motor, as said motor is not able to follow the short pulses as a result of its mass inertia and is, therefore, set to a speed corresponding to the integral average value of the pulse voltage U_{Impuls}.

In a subsequent step 206 the integral average value of the pulse voltage U_{Impuls} is determined by a control unit. The measurements required therefor may, for example, be carried out after every PWM period. However, it might also be conceivable, based on the current measured value, to extrapolate the expected measured values into the future and, based on the extrapolated values, to calculate the integral average value of the pulse voltage U_{Impuls}. The integral average value of the pulse voltage calculated in step 206 is a measure or indication of the average power consumption of the electric motor and thus allows a conclusion about the motor drive torque as well as an empirical determination of the hydraulic pressure prevailing in the parking brake circuit based thereon.

As the measured results or calculated results may be falsified by fluctuations in the on-board power system or alterations to the operating temperature of the electric motor, it may be considered to compensate for such fluctuations and alterations by standard measurements of voltage and temperature or by calculations. The same applies to tolerances in the hydraulic fluid filling volume of the brakes.

In a further step 208, it is monitored whether the integral average value of the pulse voltage U_{Impuls} has already reached or exceeded a predetermined reference value U_{ref}. It may be concluded from reaching or exceeding the reference value U_{ref} that the electric motor is subjected to a heavy load and a sufficiently high hydraulic pressure prevails in the parking brake circuit. If the comparison in step 208 leads to a negative result, the method branches back to step 206. Otherwise, in a next step 210 a tightening force assistance device is activated in order at least to maintain the pre-tightening force of the parking brake resulting from the hydraulic pressure and to transfer the parking brake, therefore, into a preferably mechanically applied state. The tightening force assistance device may, to this end, be provided with a self-locking mechanism so that, after applying the parking brake in step 210, the tightening force assistance device does not require any further electrical power supply.

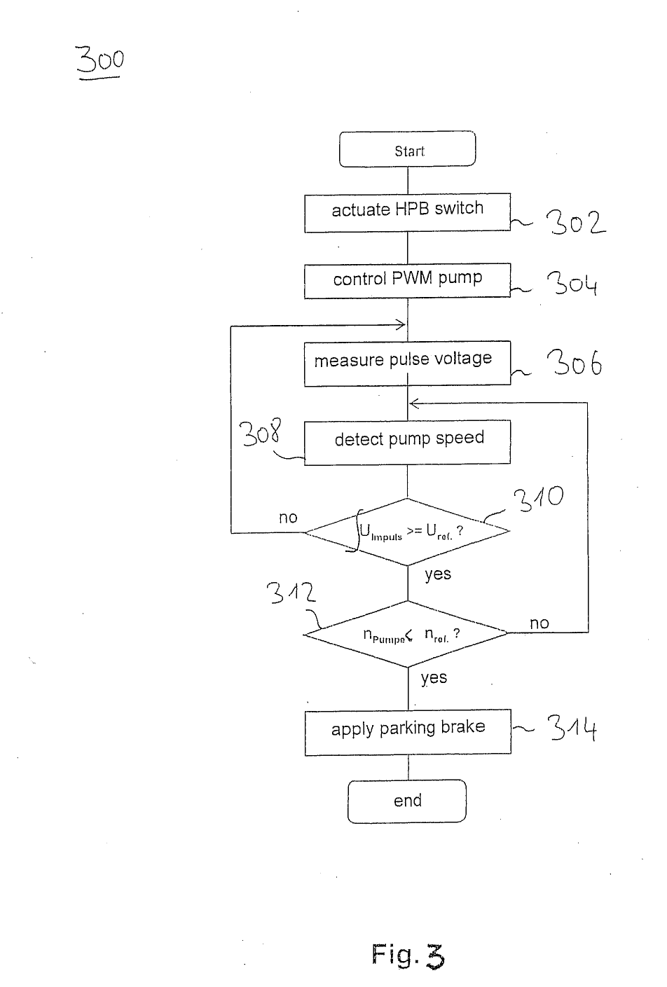

FIG. 3 shows in a flow chart 300 a further embodiment of a method for tightening a hydraulic parking brake. The steps 302, 304 and 306 correspond to the steps 202, 204 and 206, already explained with reference to FIG. 2. In a further step 308, additionally the pump speed n_{Pumpe} (or alternatively the motor speed) is detected. The detection of the speed is based on the consideration that falling speed, in terms of time, indicates a greater motor load and thus increasing hydraulic pressure in the parking brake circuit. The speed may, for example, be detected by the electromotive force (also known as generator voltage U_{G}) induced by the electric motor being measured and evaluated as a measurement of the pump speed during the interval time between the pulses.

Subsequent to the speed detection, in step 310 the monitoring of the integral average value of the pulse voltage U_{Impuls} is carried out, which has already been described in connection with step 208. Provided this average value exceeds the reference value U_{ref} in a next step 312 it is monitored whether the pump speed n_{Pumpe} is below a speed reference value n_{ref}. Provided this is not the case, the method branches from step 312 back to step 308. Otherwise, the method continues with step 314, which corresponds to step 210 already described above. The monitoring in steps 310 and 312 causes an activation of the tightening force assistance device when the power consumption rises at reducing speed.

The embodiments shown in FIGS. 2 and 3 of the method according to the invention may, for example, be implemented in the brake system shown in FIG. 1 or in a brake system of different configuration. The reference values U_{ref} and n_{ref} may be expediently detected and subsequently stored in the control device.

As the above described embodiments have shown, the pressure in the parking brake circuit may also be determined, or at least estimated, without force sensors by evaluating motor-related parameters. The invention, therefore, allows the implementation of a system without pressure sensors. The invention, however, may also be implemented in systems equipped with pressure sensors (for example as a back-up solution).

The invention makes it possible to stop the pressure build-up in the parking brake circuit at the earliest possible time. This protects the vehicle battery (in particular when the vehicle engine is switched off) and prevents overflow of the pressure compensation valves in a manner which calibrates the pressure but is associated with noise.

The embodiments described with reference to FIGS. 1 to 3 relate to a hydraulic parking brake circuit. The approach used in this connection, namely the detection of a motor-related parameter which allows a return to the hydraulic pressure may, however, also be used for determining hydraulic pressure in a service brake circuit. This applies, in particular, in the case where the hydraulic pressure in the service brake circuit is produced by means of an electromotively-operated pressure generating unit activated by pulse width modulation. For this reason, steps 204 to 208 according to FIG. 2 and steps 304 to 312 according to FIG. 3 may also be used for determining hydraulic pressure in a service brake circuit. The service brake circuit may, for example, be an electrohydraulic vehicle brake circuit based on the brake-by-wire principle.

The invention has been described with reference to preferred embodiments. For the person skilled in the art it is, however, obvious that numerous alterations and amendments may be made. The scope of the invention is, therefore, solely limited by the accompanying claims.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Method for tightening a hydraulic parking brake comprising the steps:
generating a tightening force by creating a hydraulic pressure in a parking brake circuit using a pressure generating unit driven by an electric motor;
detecting at least one motor-related parameter which permits a conclusion about the hydraulic pressure prevailing in the parking brake circuit; and
activating a tightening force assistance device depending on the at least one detected motor-related parameter to generate an assistance tightening force.

2. Method according to claim 1, wherein the tightening force assistance device is actuated when the detected motor-related parameter indicates a sufficiently high hydraulic pressure in the parking brake circuit.

3. Method according to claim 2, wherein a motor drive torque is detected.

4. Method according to claim 2, wherein a power consumption of the electric motor is detected.

5. Method according to claim 4, wherein the electric motor is activated by means of pulse width modulation.

6. Method according to claim 4, wherein the average power consumption is detected from the pulse widths.

7. Method according to claim 1, wherein one of a speed of the electric motor and the pressure generating unit is detected.

8. Method according to claim 7, wherein for detecting the speed, a generator voltage produced by the electric motor is measured.

9. Method according to claim 7, wherein a power consumption of the electric motor also is detected and further wherein the tightening force assistance device is actuated when, with reducing speed, the power consumption rises.

10. Method according to claim 2, wherein, depending on the at least one detected motor-related parameter, an additional assistance tightening force is generated by the tightening force assistance device.

11. Method according to claim 2, wherein, depending on the at least one detected motor-related parameter, the generated assistance tightening force is maintained by the tightening force assistance device.

12. Method for detecting the hydraulic pressure in a brake circuit without pressure sensors by an electromotively-operated pressure generating unit activated by means of pulse width modulation, comprising the steps:
temporal integration or extrapolation of the current pulses to detect a motor-related parameter in the form of an average power consumption; and
determining the hydraulic pressure on the basis of the detected power consumption.

13. Device for tightening a hydraulic parking brake, comprising:
an electric motor;
a pressure generating unit driven by the electric motor, which creates a hydraulic pressure for generating a tightening force in a parking brake circuit;
a tightening force assistance device for the parking brake;
a control device for detecting at least one motor-related parameter which permits a conclusion about the hydraulic pressure prevailing in the parking brake circuit, and for activating the tightening force assistance device depending on the at least one detected motor-related parameter.

14. Device according to claim 13, wherein the pressure generating unit is a component of a system for improving the driving stability, in particular one of an ABS pump and ESP pump.
